(19) United States
(12) Patent Application Publication
(10) Pub. No.: US 2023/0037299 A1
(43) Pub. Date: Feb. 9, 2023

(54) GEAR UNIT AND DRIVE TRAIN FOR A VEHICLE

(71) Applicant: ZF FRIEDRICHSHAFEN AG, Friedrichshafen (DE)

(72) Inventors: Michael Wechs, Weissensberg (DE); Fabian Kutter, Kressbronn (DE); Thomas Martin, Weissensberg (DE); Oliver Schaudt, Köln (DE)

(21) Appl. No.: 17/876,021

(22) Filed: Jul. 28, 2022

(30) Foreign Application Priority Data
Aug. 6, 2021 (DE) 10 2021 208 556.3

(51) Int. Cl. F16H 37/08; B60K 17/08; B60K 17/16; B60K 1/00

(52) U.S. Cl. CPC F16H 37/082; B60K 17/08; B60K 17/165; B60K 1/00; F16H 2200/2007; F16H 2200/2038; F16H 2200/2064; B60K 2001/001; F16H 2200/201; F16H 2200/0021; F16H 2200/2094

(57) ABSTRACT

A powertrain of a vehicle includes a stepped planetary gearset, a first gear shifting element and a second gear shifting element. The stepped planetary gearset has a first sun gear and a second sun gear, a first ring gear and a plurality of stepped planet gears rotatably mounted at a first planet carrier. The first ring gear is configured to drivingly connect to an electric machine. The first planet carrier is connectable to an output shaft of the gear unit to be fixed with respect to relative rotation. The first gear shifting element is configured to fix the second sun gear relative to a housing in a closed state, and the second gear shifting element is configured to fix the first sun gear relative to the housing in a closed state. One of the two gear shifting elements is in the closed state for driving the output shaft in rotation.

### BACKGROUND OF THE INVENTION

### 1. Field of the Invention

The invention is directed to a gear unit for a powertrain of an at least partially electrically driven vehicle. The invention is further directed to a powertrain comprising such a gear unit.

### 2. Description of the Related Art

A powertrain for a vehicle with at least one electric drive which is couplable with at least a first transmission ratio stage and a second transmission ratio stage via a driveshaft is known from the publication WO 2014/139 744 A1. At least one shifting device is provided for shifting the transmission ratio stages, this shifting device comprising at least one positively engaging shifting element and at least one frictionally engaging shifting element for carrying out power shifts. Each of the transmission ratio stages can be shifted with the positively engaging shifting element. At least one of the ratio stages can be shifted with the positively engaging shifting element as well as with the frictionally engaging shifting element.

### SUMMARY OF THE INVENTION

It is an object of the present invention to propose an alternative two-speed gear unit and an alternative powertrain with a two-speed gear unit. This object is met according to a first aspect of the invention by a gear unit for a powertrain of an at least partially electrically driven vehicle comprises a stepped planetary gearset, a first gear shifting element and a second gear shifting element. The stepped planetary gearset has a first sun gear, a second sun gear, a first ring gear and a plurality of stepped planet gears rotatably mounted on a first planet carrier. The first ring gear is configured to be drivingly connected to an electric machine. The first planet carrier is connected to an output shaft of the gear unit so as to be fixed with respect to rotation relative to it. The first gear shifting element is configured to fix the second sun gear relative to a housing in a closed state. The second gear shifting element is configured to fix the first sun gear relative to the housing in a closed state, and one of the two gear shifting elements is in the closed state for driving the output shaft in rotation. A gear unit of this kind enables a two-speed drive of the vehicle, and a ratio step of between 1.7 and 2.5, preferably a ratio step of approximately 2.0, is advantageously made possible by the gear unit. A further advantage of such a construction of the gear unit consists in the high efficiencies which can be realized.

“Operative connection” or “driving connection” means a connection between two torque-conducting parts which allows a torque or power to be transferred between these parts. In particular, the two parts are correspondingly rotatably mounted. Driving connections are connections which have no gear ratio or intermediate component parts but also those having a gear ratio or intermediate component parts. For example, two shafts or two toothed wheels can have further shafts and/or toothed wheels drivingly arranged therebetween.

The first ring gear is connected to the electric machine at least indirectly, in particular directly, i.e., fixed to rotate with a rotor or a rotor shaft of the electric machine. In rotor operation of the electric machine, the rotor shaft of the electric machine serves as output shaft of the electric machine. The first ring gear is an input shaft of the stepped planetary gearset in rotor operation of the electric machine. In rotor operation of the electric machine, electrical energy is fed to the electric machine from an energy accumulator, for example, in particular a battery, as a result of which a rotation of the rotor is brought about for generating a motive power. This motive power is provided for driving the first ring gear in rotation. In generator mode, on the other hand, electrical energy is generated by the electric machine. The output shaft of the gear unit functions as input shaft of the gear unit in generator operation of the electric machine, whereas the first ring gear is accordingly configured as an output shaft of the gear unit, and a motive power of the vehicle is conducted via the gear unit and the respective gear shifting element into the electric machine so that electrical energy is generated by the electric machine and can be fed into a battery for storage. In generator operation, the output, for example, from one or more rotating wheels of the vehicle is conducted into the electric machine via the gear unit.

The expression “at least indirectly” means that two component parts are connected to one another via at least one further component part arranged therebetween or are directly and, therefore, immediately connected to one another. Consequently, still further component parts can be arranged between shafts or toothed wheels and operatively connected to the shaft or toothed wheel, respectively.

By “shaft”, be this an input shaft, an output shaft, an intermediate shaft or the like, is understood within the meaning of the invention a rotatable component part of the powertrain for transmitting torques and via which associated components of the powertrain are connected to one another so as to co-rotate or via which such a connection is produced when a corresponding shifting element or gear shifting element is actuated.

The first ring gear is in meshing engagement with a first toothed wheel of the respective stepped planet gear of the stepped planetary gearset which in turn meshingly engages with the first sun gear. The respective stepped planet gear has a second toothed wheel which is arranged coaxial to and so as to co-rotate with a first toothed wheel and which is in meshing engagement with the second sun gear. The two toothed wheels of the respective stepped planet gear have different diameters and numbers of teeth. In particular, the first toothed wheel has a smaller diameter than the second toothed wheel. The advantage in providing a stepped planetary gearset consists in that a second ring gear can be dispensed with so that a cost-optimized gear unit is provided. Toothed wheels which engage with one another or mesh with one another transmit a rotational speed and torque via their teeth which mesh with one another.

The first sun gear and second sun gear are arranged coaxial to one another and rotatable relative to one another, and one of the sun gears can be axially guided at least partially through the other sun gear. Consequently, at least one of the sun gears is connected to a hollow shaft.

Depending on the shifting position or state of the two gear shifting elements, the first planet carrier transmits a motive power with a respective gear ratio at least indirectly to driven shafts of the vehicle which are at least indirectly connected, respectively, to at least one wheel of the vehicle. The driven shafts are arranged coaxial to the output axis. Therefore, at least one wheel of the vehicle is at least indirectly driven in rotation via the driven shaft by the motive power generated with the electric machine and converted at least with the gear unit.

In order to form a gear step, either the first sun gear or the second sun gear is connected to the housing via the respective gear shifting element.

By “gear shifting element” is meant a connection part by which at least one torque-transmitting part is drivingly connectible to a further torque-transmitting part or to a stationary or fixed part. The respective gear shifting element is shiftable between at least one open state and a closed state. In the open state, the gear shifting element cannot transmit any torque between two parts cooperating with the gear shifting element. In the closed state, the gear shifting element can transmit a torque between the two parts cooperating with the gear shifting element. Insofar as a driving connection exists between two gear unit elements, torques and forces and—depending on the construction of the gear unit elements—possibly a rotational speed are transmitted from a gear unit element to the other gear unit element. The respective gear shifting element is formed to be positively engaging or frictionally engaging, for example.

When the second gear shifting element is in the closed state or is shifted into the closed state and the first gear shifting element is open, a motive power is transmitted from the gear unit input to the gear unit output, or vice versa, in a first gear or a first gear step, namely, with a first gear ratio or a first transmission ratio. The first sun gear of the gear unit is supported against the housing or connected to the housing so as to be fixed with respect to rotation relative to it. In the closed state of the second gear shifting element, the first gear shifting element is in the open state in order to transmit a motive power with a first gear ratio to the output shaft via the first planet carrier of the gear unit. For example, a first gear ratio is greater than 1.

When the first gear shifting element is in the closed state, or is shifted into the closed state, and the second gear shifting element is open, a motive power is transmitted from the gear unit input to the gear unit output, or vice versa, in a second gear or second gear step, namely, with a second gear ratio or a second transmission ratio. The second sun gear of the gear unit is supported against the housing or connected to the housing so as to be fixed with respect to rotation relative to it. In the closed state of the first gear shifting element, the second gear shifting element is in the open state in order to transmit a motive power with a second gear ratio to the output shaft of the gear unit via the first planet carrier. Consequently, either the first gear shifting element or the second gear shifting element is in the closed state for rotationally driving the output shaft of the gear unit. A second gear ratio is greater than 1, for example. Therefore, either the first gear shifting element or the second gear shifting element is closed to drive the vehicle.

If both gear shifting elements are open, no motive power is introduced into the gear unit and, accordingly also, no motive power is transmitted to the output shaft of the gear unit. Thus the gear unit is in idle. On the other hand, if both gear shifting elements are closed, a rotation of the output shaft is blocked. In this respect, the two gear shifting elements are simultaneously in a closed state in order to realize a park lock function.

According to an embodiment form of the invention, there is provided, in addition, a third gear shifting element which is so configured that, in a closed state, it connects two of the elements of the stepped planetary gearset in the form of the first sun gear, the second sun gear, the first ring gear and the first planet carrier to one another so as to be fixed with respect to rotation relative to one another. In so doing, as a result of the closed state of the third gear shifting element, there is a rotational driving of the output shaft. Accordingly, by actuating the third gear shifting element, a locking of the stepped planetary gearset and, therefore, a direct through-drive from the first ring gear to the output shaft can advantageously be produced. A further, third gear speed of the gear unit can be provided in this way, for which purpose the first gear shifting element and the second gear shifting element must be open.

Accordingly, in the closed state, the third gear shifting element connects two of the elements of the stepped planetary gearset formed by the first sun gear, the second sun gear, the first ring gear and the first planet carrier. Specifically, the third gear shifting element can connect the first sun gear and the second sun gear, the first sun gear and the first ring gear, the second sun gear and the first ring gear, the first sun gear and the first planet carrier, the second sun gear and the first planet carrier, or the first ring gear and the first planet carrier to one another so as to be fixed with respect to rotation relative to one another. A locking of the stepped planetary gearset can be achieved in this way.

The first gear shifting element and/or the second gear shifting element and/or the third gear shifting element are preferably configured as a frictionally engaging shifting element. In particular, the frictionally engaging shifting element can be configured as a friction-type shifting element, especially as a multiple-disk clutch or cone clutch, in order to produce a frictionally engaging connection between the respective sun gear and the housing. A frictionally engaging shifting element is one that introduces a normal force to two parts or surfaces of gear unit elements to be connected to one another, a mutual displacement of the parts or surfaces being prevented until a counterforce brought about substantially by static friction is exceeded. Accordingly, a frictional engagement is formed for transferring a torque between the gear unit elements to be connected.

According to the first aspect of the invention, it is advantageously possible with the gear unit according to the invention to powershift between the gears, that is, shift between a first gear and second gear and possibly second gear and third gear, or vice versa, without interrupting the motive power at the output or at the output shaft particularly during a shifting process. It is advantageous that separate power shifting elements need not be provided for this purpose. Rather, the gear unit can be outfitted with frictionally engaging gear shifting elements having a simpler construction. For traction shifting or coasting shifting between respective consecutive gears, it is required that at least one of the gear shifting elements in question is constructed as a frictionally engaging gear shifting element or as a friction-type shifting element. However, for traction shifting and coasting shifting by the gear shifting elements, it is required that the gear shifting elements taking part in the gear change are constructed as frictionally engaging gear shifting elements. On the other hand, the other respective gear shifting element not configured as a frictionally engaging shifting element can be configured as a positively engaging gear shifting element or jaw-type shifting element. Accordingly, a gear shifting element or both relevant gear shifting elements can realize a power shift. A gear shifting element which realizes a power shift is a shifting element that allows two gear unit elements to be connected to one another, while a motive power, particularly a torque, is applied to the one gear unit element so that the motive power is transmitted to the other gear unit element after closing. It is not necessary to synchronize the speeds of the relevant gear unit elements before a power shifting element is closed.

Alternatively, the first gear shifting element and/or the second gear shifting element and/or third gear shifting element are configured as a positively engaging shifting element. A positively engaging shifting element can be formed, for example, as a jaw-type shifting element for realizing a positively engaging connection between the respective sun gear and the housing. A positively engaging shifting element is one in which two parts of the gear unit engage one inside the other and form a positive engagement for transmitting a torque between two gear unit elements, in particular between the housing and the first sun gear or second sun gear, respectively. Compared to the frictionally engaging shifting element, a positively engaging shifting element is cheaper and, above all, efficiency-optimized.

According to an embodiment form of the invention, two gear shifting elements are configured jointly as double shifting element. This means that the respective gear shifting elements are arranged directly axially adjacent one another and the two gear shifting elements are combined to form a unit. This is particularly advantageous when both shifting elements are constructed as jaw-type shifting elements for realizing a positively engaging connection between the respective sun gear and the housing. In this case, no power shifting is possible between first gear and second gear, or vice versa, but axial installation space for the gear unit can be saved by arranging and configuring the gear shifting elements in this way. Moreover, the construction of the gear shifting elements as jaw-type shifting elements facilitates realization of the park lock function, i.e., when the two gear shifting elements are moved into, or are in, the closed state. Within the meaning of the invention, particularly the first gear shifting element and the second gear shifting element or the first gear shifting element and the third gear shifting element, if any, can be configured as a double shifting element.

According to a second aspect of the invention, a powertrain for an at least partially electrically driven vehicle comprises a gear unit according to the first aspect of the invention, an electric machine and a differential which drivingly connects the gear unit to two driven shafts arranged coaxial to an output axis. A powertrain of this kind is compactly constructed with the gear unit according to the invention and realizes a comparatively high ratio step.

The differential is preferably configured as a bevel gear differential. Further, other alternative embodiment forms of the differential are also conceivable, for example, a spur gear differential or planetary differential. The motive power coming from the gear unit with a first gear ratio or second gear ratio is transmitted from the output shaft of the gear unit to the two driven shafts at least indirectly via the differential. The differential distributes the motive power, i.e., a rotational speed and a torque, to the driven shafts. The differential is also arranged on the output axis so that the driven shafts extend coaxial to the output axis. A differential configured as a bevel gear differential has two output elements on the wheel side, particularly a first driven wheel and a second driven wheel. The two driven wheels mesh, respectively, with a compensating element. The compensating elements are mounted in a differential carrier so as to be rotatable around their own axes. The respective driven wheel is connected to the respective driven shaft so as to be fixed with respect to rotation relative to it. The differential is driven via the differential carrier.

The powertrain preferably comprises a planetary gear assembly which is drivingly connected to the output shaft of the gear unit and has at least a first planetary gearset. The first planetary gearset is advantageously configured as a negative planetary gearset, and an overall gear ratio is increased by the respective planetary gearset of the planetary gear assembly depending on the respective gear speed selected in the gear unit. An overall gear ratio between 6 and 13.5 is preferably realizable by the planetary gear assembly arranged in the power flow downstream of the gear unit. A negative planetary gearset is formed of a sun gear, planet carrier and ring gear. The planet carrier guides at least one, but preferably a plurality of rotatably mounted planet gears, each of which meshes or is in meshing engagement with the sun gear as well as with the surrounding ring gear.

In particular, the first planetary gear set of the planetary gear assembly has a third sun gear, a second ring gear which is fixed with respect to the housing and a plurality of planet gears rotatably mounted on a second planet carrier, the third sun gear being connected to the first planet carrier of the gear unit so as to be fixed with respect to rotation relative to it. The planetary gear assembly is formed to be axially compact, the planet gears being in meshing engagement with the second ring gear as well as with the third sun gear. Further, the second planet carrier rotatably receiving the planet gears is operatively connected to a second output shaft which can advantageously be guided axially through the gear unit and/or the electric machine in order to conduct the motive power into the differential and save axial installation space at the same time.

A differential carrier of the differential is preferably connected to the second planet carrier of the planetary gear assembly so as to be fixed with respect to rotation relative to it. Further, it is conceivable that the second output shaft is formed to be at least partially hollow so that one of the two driven shafts of the differential can be guided through axially. In other words, the second output shaft can be arranged radially inside of the first planet carrier of the gear unit, and one of the two driven shafts of the differential can be arranged radially inside of the second output shaft.

At least the gear unit and/or the differential are/is preferably arranged at least partially or completely spatially inside of the rotor of the electric machine. Arranging the gear unit and/or the differential radially inside of the rotor can save axial installation space of the powertrain. Consequently, the powertrain is formed axially compact. For example, the gear unit is arranged completely spatially inside of the rotor of the electric machine. The differential is arranged completely spatially inside of the rotor of the electric machine, for example.

According to an embodiment example of the invention, at least a first transmission stage is drivingly arranged between the output shaft of the gear unit and the differential. In particular, the output shaft of the gear unit is arranged paraxial to the output axis. Accordingly, the output axis on which the driven shafts of the powertrain are arranged is paraxial to an input axis. At least the output shaft of the gear unit, preferably also the input shaft of the gear unit and/or the rotational axis of the rotor of the electric machine are arranged coaxial to the input axis.

The first transmission stage is advantageously formed to increase the overall gear ratio and preferably comprises at least two tooth wheels in meshing engagement with one another, the rotational axis of the first toothed wheel being arranged coaxial to the output shaft of the gear unit, and the rotational axis of a further toothed wheel being arranged coaxial to the output axis. The first transmission stage can comprise a spur gear stage, for example.

Additionally, a second transmission stage can be provided, and the motive power is introduced at least indirectly into the differential from the gear unit via the first transmission stage and the second transmission stage. An intermediate shaft is provided which is arranged parallel to the output shaft of the gear unit and to the output axis of the vehicle. Two further toothed wheels are preferably arranged on the intermediate shaft. The first toothed wheel of the intermediate shaft meshingly engages with a toothed wheel which is operatively connected at least indirectly to the output shaft, and the second toothed wheel of the intermediate shaft meshingly engages with a further toothed wheel at least indirectly operatively connected to the differential. The two transmission stages are configured as spur gear stages, for example, and can increase the overall gear ratio, the gear ratio being carried out in two stages. As a result of the axial offset, axial installation space of the powertrain is saved particularly along the input axis.

As an alternative to the bevel gear differential, the differential can be configured as an integral differential, as it is called, which has a second planetary gearset and a third planetary gearset, each planetary gearset being drivingly connected to a respective driven shaft. A first output torque is transmittable to the first driven shaft by the second planetary gearset, and a supporting torque of the second planetary gearset can be converted in the third planetary gearset in such a way that a second output torque corresponding to the first output torque is transmittable to the second driven shaft.

By an “integral differential” is meant a differential with two planetary gearsets in which the second planetary gearset is drivingly connected to an input shaft of the differential and also to the third planetary gearset. The input shaft of the differential is at least indirectly connected to the output shaft of the gear unit. Alternatively, the input shaft of the differential can be connected integral to the output shaft of the gear unit. The second planetary gearset is drivingly connected to the first driven shaft. The third planetary gearset is drivingly connected to the second driven shaft. Further, the third planetary gearset is at least indirectly supported at a stationary housing of the gear unit or at the chassis of the motor vehicle, that is, connected thereto so as to be fixed with respect to relative rotation.

By an integral differential, the input torque of the input shaft of the differential is convertible and can be divided and transmitted to the two driven shafts in a defined ratio. The input torque is preferably transmitted at fifty percent, respectively, i.e., halved, to the driven shafts. Accordingly, the differential has no component part to which the sum of the two output torques is applied. Beyond this, with the speeds of the driven shafts being identical, the differential has no gear teeth revolving as a block or revolving without rolling motion. In other words, there is always a relative movement of the component parts of the respective planetary gearset which are in meshing engagement with one another irrespective of the output speeds of the driven shafts. The differential performs the function of generating the overall gear ratio and functions as a differential at the same time. In other words, the integral differential realizes a torque increase and an apportioning of motive power. Further, there is also a reduction in weight.

The integral differential and the driven shafts are preferably adapted to be arranged coaxial to the output axis of the vehicle. Accordingly, the output axis extends coaxial to the input axis, namely, in particular, coaxial to the rotational axis of the rotor of the electric machine, coaxial to the input shaft of the gear unit and/or coaxial to the output shaft of the gear unit.

The powertrain according to the invention and the gear unit according to the invention are useable in all-electric vehicles as well as in hybrid vehicles which are drivable partially electrically and partially by a separate internal combustion engine. Depending on the construction and quantity of driven axles, the vehicle can also comprise two or more such powertrains or gear units, respectively, and one axle, a plurality of axles or all axles of the vehicle can be outfitted with the respective powertrain according to the invention and can be constructed to be drivable by means thereof. Such a vehicle is a motor vehicle, particularly a passenger car, utility vehicle or truck.

It shall be understood that features of the present solutions described in the claims and/or drawings can also possibly be combined so that the achievable advantages and effects can be implemented cumulatively.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described in the following with reference to drawings depicting the various embodiment forms of the invention. Like or similar elements are designated with consistent reference numerals. In particular, the drawings show:

FIG. 1 a vehicle comprising a powertrain according to the invention with a gear unit according to the invention in a first embodiment form;

FIG. 2 a schematic depiction of the gear unit according to the invention shown in FIG. 1;

FIG. 3 a schematic diagram of a shifting matrix relating to shifting states for driving with a gear unit according to the invention according to FIG. 2;

FIG. 4 a schematic depiction of the powertrain according to the invention with the gear unit according to the invention shown in FIG. 1 and FIG. 2;

FIG. 5 a schematic depiction of the powertrain according to the invention with the gear unit according to the invention in a second embodiment form;

FIG. 6 a schematic depiction of the powertrain according to the invention with the gear unit according to the invention in a third embodiment form;

FIG. 7 a schematic depiction of the powertrain according to the invention with the gear unit according to the invention in a seventh embodiment form;

FIG. 8 a schematic depiction of the powertrain according to the invention with the gear unit according to the invention in a fifth embodiment form;

FIG. 9 a schematic depiction of the powertrain according to the invention with the gear unit according to the invention in a sixth embodiment form;

FIG. 10 a schematic depiction of the powertrain according to the invention with the gear unit according to the invention in a seventh embodiment form;

FIG. 11 a schematic depiction of the powertrain according to the invention with the gear unit according to the invention in a eighth embodiment form;

FIG. 12 a schematic depiction of the powertrain according to the invention with the gear unit according to the invention in a ninth embodiment form;

FIG. 13 a schematic depiction of the powertrain according to the invention with the gear unit according to the invention in a tenth embodiment form;

FIG. 14 a schematic depiction of the powertrain according to the invention with the gear unit according to the invention in a eleventh embodiment form;

FIG. 15 a schematic depiction of the powertrain according to the invention with the gear unit according to the invention in a twelfth embodiment form;

FIG. 16 a schematic depiction of the powertrain according to the invention with the gear unit according to the invention in a thirteenth embodiment form;

FIG. 17 a schematic depiction of the powertrain according to the invention with the gear unit according to the invention in a fourteenth embodiment form;

FIG. 18 a schematic depiction of the powertrain according to the invention with the gear unit according to the invention in a fifteenth embodiment form;

FIG. 19 a schematic depiction of the powertrain according to the invention with the gear unit according to the invention in a sixteenth embodiment form; and

FIG. 20 a schematic diagram of a shifting matrix relating to shifting states for driving with a gear unit according to the invention according to one of FIGS. 9 to 19.

### DETAILED DESCRIPTION OF THE PRESENTLY PREFERRED EMBODIMENTS

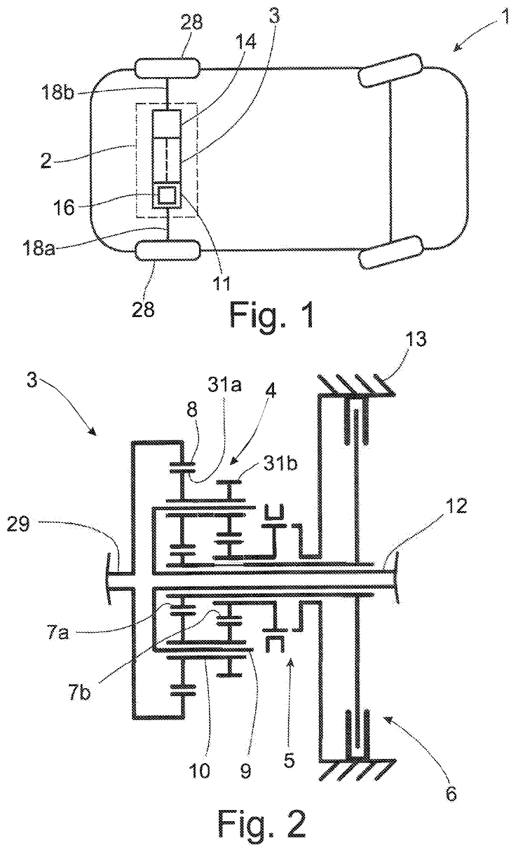

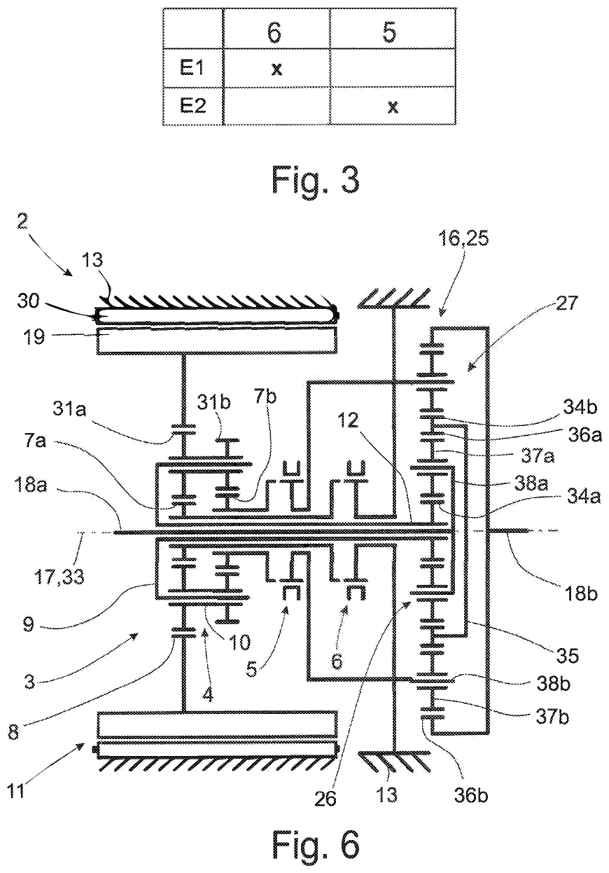

FIG. 1 shows an electrically driven vehicle 1 with a powertrain 2 according to the invention in a first embodiment form. The powertrain 2 comprises an electric machine 11 which generates power and introduces this power into a gear unit 3. The gear unit 3 is shown in FIG. 2, and the associated shifting matrix is shown in FIG. 3. The gear unit 3 is drivingly connected to a planetary gear assembly 14 which increases an overall gear ratio and transmits the power to a differential 16 which is arranged downstream in the power flow, in this instance spatially inside of the electric machine 11. The differential 16 divides the motive power between a first driven shaft 18a and a second driven shaft 18b which are in turn operatively connected to a driven wheel 28 of the vehicle 1 in each instance.

The vehicle 1 can further comprise an energy accumulator—not shown—which is supplied with electrical energy by the electric machine 11 in generator mode when the power flow is reversed. The energy accumulator can be a battery or the like, for example. Accordingly, in generator mode, by the electric machine 11, electrical energy is generated, stored and conserved for resupplying the electric machine 11.

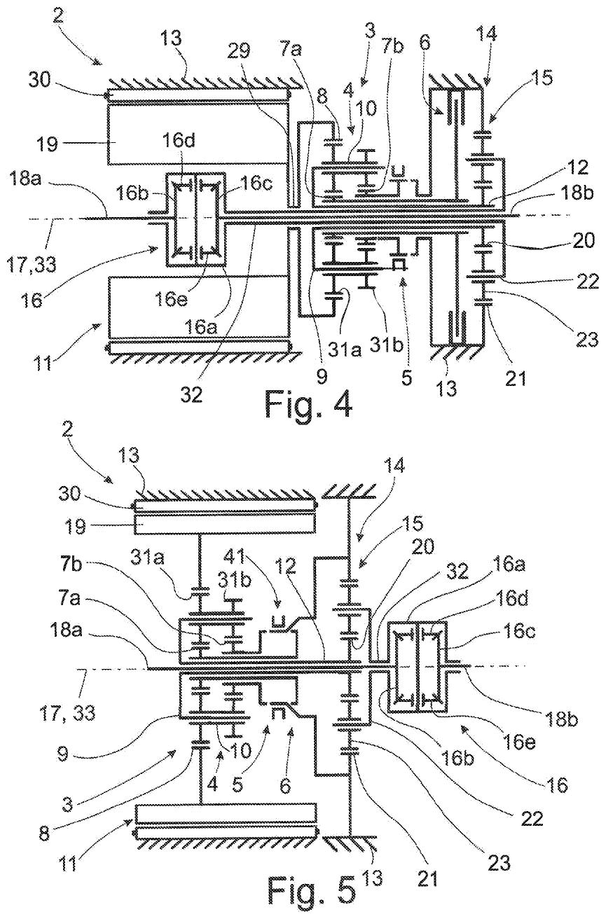

The gear unit 3 from FIG. 1 is shown in a detailed diagram in FIG. 2. The gear unit 3 according to FIG. 2 can be acted upon by a motive power in the powertrain 2 according to FIG. 4 via an input shaft 29 with a rotor 19 of the electric machine 11, which rotor 19 is mounted so as to be rotatable relative to a stator 30. The input shaft 29 can be connected to the rotor 19 integrally or in more than one part; in any case, a rotationally locked driving connection exists.

The gear unit 3 comprises a stepped planetary gearset 4 with a first ring gear 8 which is connected to the input shaft 29 so as to be fixed with respect to rotation relative to it, a first sun gear 7a, a second sun gear 7b arranged coaxial thereto, and a plurality of stepped planet gears 10 rotatably mounted at a first planet carrier 9. The gear unit 3 further has a first gear shifting element 5 and a second gear shifting element 6. The first gear shifting element 5 is configured such that, in a closed state, it connects the second sun gear 7b to a housing 13 so as to be fixed with respect to rotation relative to it, and the second gear shifting element 6 is configured such that, in a closed state, it connects the first sun gear 7a to the gear unit 13 so as to be fixed with respect to rotation relative to it. To drive the output shaft 12 in rotation, one of the two gear shifting elements 5, 6 is in the closed state.

The driving of the gear unit 3 is carried out via the first ring gear 8 which is in meshing engagement with a first toothed wheel 31a of the respective stepped planet gear 10. Further, the respective toothed wheel 31a is in meshing engagement with the first sun gear 7a. In addition to the first toothed wheel 31a, each stepped planet gear 10 also has a second toothed wheel 31b which is axially adjacent the first toothed wheel 31a and connected thereto so as to be fixed with respect to rotation relative to it and which is in meshing engagement with a second sun gear 7b. The two toothed wheels 31a, 31b have different diameters and numbers of teeth so that, depending on the toothed wheel 31a, 31b via which the motive power is transmitted or depending on which gear shifting element 5, 6 is closed or open, two different gear ratios can be realized, both of which are, however, greater than 1. In the present case, the first toothed wheel 31a of the respective stepped planet gear 10 has a smaller diameter than the second toothed wheel 31b of the respective stepped planet gear 10.

When the second gear shifting element 6 is in a closed state and the first gear shifting element 5 is in an open state, the first sun gear 7a is connected to the housing 13 so as to be fixed with respect to rotation relative to it so that a motive power of the electric machine 11 is transmitted via the first ring gear 8 to the stepped planet gears 10 and from there, via the first planet carrier 9, to an output shaft 12 of the gear unit 3. When the first gear shifting element 5 is in a closed state and the second gear shifting element 6 is in an open state, the second sun gear 7a is connected to the housing 13 so as to be fixed with respect to rotation relative to it so that a motive power of the electric machine 11 is transmitted via the first ring gear 8 to the stepped planet gears 10 and from there, via the first planet carrier 9, to an output shaft 12 of the gear unit 3. In an open state of the respective gear shifting element 5, 6, no torque is transmitted via the respective gear shifting element 5, 6, whereas in a closed state of the respective gear shifting element 5, 6 a torque is transmitted via the respective gear shifting element 5, 6.

FIG. 3 shows the shifting matrix for a first gear step E1 and a second gear step E2 of the gear unit 3. The respective gear shifting element 5, 6 is closed where indicated by the “X” and open where there is no “X”. An electric forward drive of the vehicle 1 with respective gear ratio is realized via the respective gear step E1, E2. When the second gear shifting element 6 is closed and the first gear shifting element 5 is open, the second gear step E2 is engaged and a second gear ratio which is not equal to the first gear ratio is accordingly realized. This shifting matrix applies to all of the depicted embodiment examples of the invention. Traction power shifting and/or coasting power shifting may be realized depending on the construction of the gear shifting elements 5, 6. In such a case, the respective gear shifting element 5, 6 is configured as a powershift element.

According to FIG. 2, the first gear shifting element 5 is configured as a positively engaging shifting element, in this case as a jaw-type shifting element. In the closed state of the first gear shifting element 5, a positively engaging connection is accordingly produced between the second sun gear 7b and the housing 13. Ideally, these parts are synchronized before entering the positively engaging connection. On the other hand, the second gear shifting element 6 is formed in the present case as frictionally engaging shifting element, in this instance as a disk-type shifting element. In the closed state of the second gear shifting element 6, a frictionally engaging connection is produced between the first sun gear 7a and the housing 13. A synchronization of the rotational speeds of the parts is not required, and a frictionally engaging shifting element is suitable as power shifting element. In other words, the second gear shifting element 6 realizes a traction power shifting from gear step E1 into gear step E2, or vice versa. The load during shifting processes between gear steps E1, E2 is supportable by the first gear shifting element 5 configured as positively engaging until the second gear shifting element 6 is completely open or closed to prevent a load decrease at the output particularly during shifting processes.

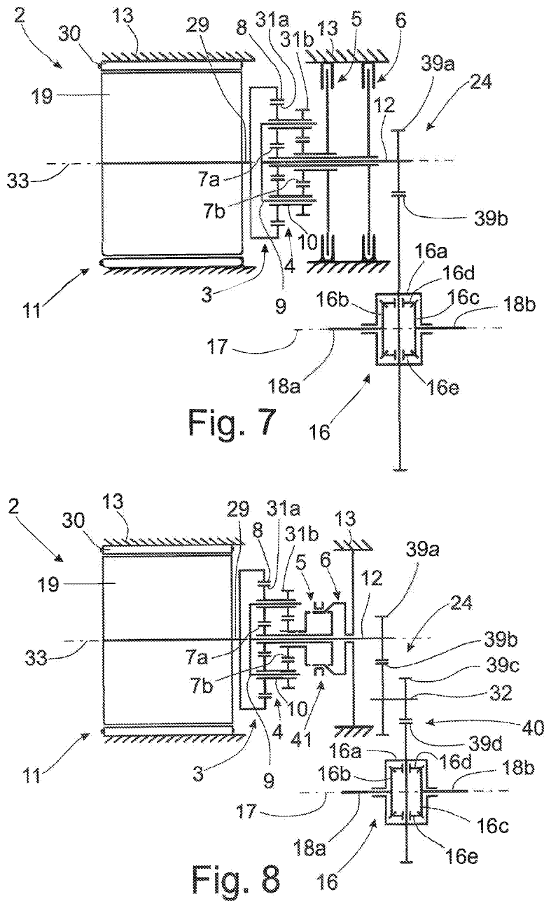

FIG. 4 shows the powertrain 2 which comprises the gear unit 3 described above. In this respect, reference is made to the statements referring to FIG. 1 to FIG. 3. FIG. 4 also shows the electric machine 11 which is connected via the input shaft 29 to the first ring gear 8 so as to be fixed with respect to rotation relative to it. Alternatively, the two gear shifting elements 5, 6 may be configured as in the respective embodiment form according to FIG. 5, FIG. 6 or FIG. 7. Further, the powertrain 2 has a planetary gear assembly 14 with a first planetary gearset 15. In the present case, the first planetary gearset 15 is configured as a negative planetary gearset and comprises a third sun gear 20 connected to the output shaft 12 of the gear unit 3 so as to be fixed with respect to rotation relative to it, a stationary second ring gear 21 which is connected to the housing 13 so as to be fixed with respect to rotation relative to it, and a plurality of planet gears 23 rotatably mounted at a second planet carrier 22. The third sun gear 20 is drivingly connected to the first planet carrier 9 of the gear unit 3 via output shaft 12 such that the planetary gear assembly 14 is subsequently operatively connected to the output shaft 12 on the drive side. The output of the planetary gear assembly 14 is carried out via the second planet carrier 22 which is drivingly connected to a differential 16. Total gear ratios between 6 and 13.5, for example, can be realized by such a combination comprising gear unit 3 and planetary gear assembly 14.

In the present case, the differential 16 is configured as a bevel gear differential and drivingly connects the gear unit 3 via the planetary gear assembly 14 to the two driven shafts 18a, 18b arranged coaxial to an output axis 17, the second driven shaft 18b being guided through the gear unit 3 and the planetary gear assembly 14 in the present instance. The bevel gear differential 16 known from the prior art has two output elements on the wheel side which are configured as a first driven wheel 16b and second driven wheel 16c. The driven wheels 16b, 16c mesh, respectively, with a compensating element 16d, 16e. The compensating elements 16d, 16e are mounted in a differential carrier 16a so as to be rotatable around their own axes. The first driven wheel 16b is connected to the first driven shaft 18a so as to be fixed with respect to rotation relative to it, and the second driven wheel 16c is connected to the second driven shaft 18b so as to be fixed with respect to rotation relative to it. The differential carrier 16a of the differential 16 is connected via an intermediate shaft 32 to the second planet carrier 22 so as to be fixed with respect to rotation relative to it, the intermediate shaft 32 being guided through the gear unit 3 coaxial to the input shaft 29 and output shaft 12 of the gear unit 3 and connected to the differential carrier 16a. The differential 16 is arranged completely spatially inside of the rotor 19 of the electric machine 11 in order to save axial installation space. Accordingly, in this case the output axis 17 extends coaxial to an input axis 33, and the rotational axis of the rotor 19, the input shaft 29 and the output shaft 12 of the gear unit 3 are arranged coaxial to the input axis 33. Consequently, the gear unit 3 is arranged axially between the electric machine 11 and the differential 16 on one side and the planetary gear assembly 14 on the other side.

The powertrain according to FIG. 5 comprises the gear unit 3 from FIG. 2 with the difference that the two gear shifting elements 5, 6 are configured as jaw-type shifting elements and are combined to form a double shifting element 41. Therefore, reference is made to the statements relating to the gear unit 3 from FIG. 2. Alternatively, the two gear shifting elements 5, 6 may be configured as in the respective embodiment form according to FIG. 4, FIG. 6 or FIG. 7. Reference is made to the description relating to FIG. 3 for the shifting between the first gear step E1 and second gear step E2. The gear unit 3 comprising the stepped planetary gearset 4 and the two gear shifting elements 5, 6 is arranged spatially completely inside of the rotor 19 of the electric machine 11 in order to save axial installation space and make the powertrain 2 more compact. The gear shifting elements 5, 6 are arranged directly adjacent one another coaxial to the input axis 33 and output axis 17 and together form the double shifting element 41 which is compactly comprised of the two gear shifting elements 5, 6. The gear shifting elements 5, 6 realize a positively engaging connection between the housing 13 and first sun gear 7a or second sun gear 7b, respectively, in the closed state. A particularly cost-optimized and efficiency-optimized clutch system is provided in this way.

The first planetary gearset 15 of the planetary gear assembly 14 is configured as a negative planetary gearset and comprises a third sun gear 20 connected to the output shaft 12 of the gear unit 3 so as to be fixed with respect to rotation relative to it, a stationary second ring gear 21 connected to the housing 13 so as to be fixed with respect to rotation relative to it, and a plurality of planet gears 23 rotatably mounted at a second planet carrier 22. The third sun gear 20 is connected to the first planet carrier 9 of the gear unit 3 via output shaft 12 so as to be fixed with respect to rotation relative to it such that the planetary gear assembly 14 is subsequently operatively connected to the output shaft 12 on the drive side. The output of the planetary gear assembly 14 is carried out via the second planet carrier 22 which is connected to a differential carrier 16a of the differential 16 so as to be fixed with respect to rotation relative to it. The differential 16 is configured as a bevel gear differential and is further identical to the differential 16 according to FIG. 4 so that the relevant statements apply here. Total gear ratios of between 6 and 13.5, for example, can be achieved by such a combination comprising gear unit 3 and planetary gear assembly 14.

The differential 16 drivingly connects the gear unit 3 to the driven shafts 18a, 18b via the planetary gear assembly 14. In the present case, the first driven shaft 18a is guided axially through the gear unit 3 and the electric machine 11. The planetary gear assembly 14 is arranged axially between the electric machine 11 and the gear unit 3 on the one hand and the differential 16 on the other hand. Alternatively, it is conceivable that the differential 16 is also arranged together with the gear unit 3 spatially inside of the rotor 19 of the electric machine 11 in order to save additional axial installation space. The differential 16 is drivingly connected to the second planet carrier 22 via an intermediate shaft 32. The intermediate shaft 32 is arranged coaxial to the output shaft 12 of the gear unit 3. Here, too, the output axis 17 is arranged coaxial to an input axis 33.

The powertrain 2 according to FIG. 6 comprises the gear unit 3 from FIG. 2 with the difference that the two gear shifting elements 5, 6 are configured as jaw-type shifting elements. Therefore, reference is made to the statements pertaining to the gear unit 3 from FIG. 2. Reference is made to the description of FIG. 3 for the shifting between the first gear step E1 and the second gear step E2. FIG. 6 shows a third embodiment example of the powertrain 2 according to the invention. In the present instance, the gear unit 3 comprising the stepped planetary gearset 4 and the two gear shifting elements 5, 6 are arranged spatially completely inside of the rotor 19 of the electric machine 11 in order to save axial installation space of the powertrain 2. The gear shifting elements 5, 6 realize a positively engaging connection between the housing 13 and the first sun gear 7a or second sun gear 7b, respectively, in the closed state. A particularly cost-optimized and efficiency-optimized clutch system is provided in this way. Alternatively, it is conceivable that the respective gear shifting elements 5, 6 formed in each instance as jaw-type shifting element are combined and configured as a double shifting element as in FIG. 5. Further alternatively, the two gear shifting elements 5, 6 can be configured as in the respective embodiment form according to FIG. 4 or FIG. 7.

In contrast to the powertrains 2 according to FIG. 4 and FIG. 5 which have a differential 16 configured as a bevel gear differential, the powertrain 2 according to FIG. 6 comprises a differential 16 configured as an integral differential 25 with a second planetary gearset 26 and third planetary gearset 27. The two planetary gearsets 26, 27 are arranged either axially adjacent one another or radially one above the other depending on the requirements of the integral differential 25, particularly the gear ratio to be realized by the integral differential 25. In the present case, the planetary gearsets 26, 27 are arranged radially one above the other so that axial installation space of the powertrain 2 is saved. In other words, the planetary gearsets 26, 27 lie in a common plane perpendicular to the driven shafts 18a, 18b or output axis 17, respectively. Consequently, the integral differential 25 is constructed in a radially nested type of construction.

A first output torque can be transmitted to the first driven shaft 18a by the second planetary gearset 16. A supporting torque of the second planetary gearset 26 acting opposite the first output torque is transmitted to the third planetary gearset 27 and is convertible in the third planetary gearset 27 in such a way that a second output torque corresponding to the first output torque can be transmitted to the second driven shaft 18b. Consequently, the integral differential 25 is configured as planetary gear assembly. The integral differential 25 is operatively connected to the gear unit 3 via the input shaft of the integral differential 25 which is simultaneously the output shaft 12 of the gear unit 3. The output at the integral differential 25 is carried out via the two driven shafts 18a, 18b. In other words, a motive power is distributed to two driven shafts 18a, 18b by the integral differential 25. In the present case, the first driven shaft 18a extends in direction of the gear unit 3 and electric machine 11 and is axially guided through the gear unit 3 and the electric machine 11. The second driven shaft 18b extends away from the powertrain 2 in the opposite direction. Due to the fact that the integral differential 25 which increases a torque coming from the gear unit 3 is only arranged at the end of the powertrain 2, the component parts arranged upstream thereof in the power flow can be formed comparatively small and slender so that production is more economical and the overall weight of the powertrain 2 is reduced. The driven shafts 18a, 18b, the integral differential 25, the electric machine 11 and the gear unit 3 are arranged coaxial to the input axis 33 of the gear unit 3 and to the output axis 17 of the vehicle 1.

The output shaft 12 of the gear unit 3 is connected to a fourth sun gear 34a of the second planetary gearset 26 so as to be fixed with respect to rotation relative to it. Accordingly, the first planet carrier 9 is connected to the fourth sun gear 34a so as to be fixed with respect to rotation relative to it. The transmission of power from the second planetary gearset 26 to the third planetary gearset 27 is carried out via a coupling shaft 35 which is connected to a third ring gear 36a of the second planetary gearset 26 so as to be fixed with respect to rotation relative to it on the one hand and, on the other hand, is connected to a fifth sun gear 34b of the third planetary gearset 27 so as to be fixed with respect to rotation relative to it. Consequently, the coupling shaft 35, the third ring gear 36a and the fifth sun gear 34b are connected integral with one another. The coupling shaft 35 with the third ring gear 36a and the fifth sun gear 34b can also be configured as a ring gear which has not only an inner toothing but also an outer toothing. A plurality of second planetary gears 37a is arranged spatially between the fourth sun gear 34a and the third ring gear 36a, in the present instance so as to be rotatable on a rotatably mounted third planet carrier 38a. Further, a plurality of third planetary gears 37b which are arranged in the present case so as to be rotatable on a fourth planet carrier 38b fixed with respect to the housing are arranged on the same radially extending plane and radially outside of the second planetary gearset 26 spatially between the fifth sun gear 34b and a fourth ring gear 36b of the third planetary gearset 27. The first output on the first driven shaft 18a is carried out via the third planet carrier 38a of the second planetary gearset 26, which third planet carrier 38a is connected to the first driven shaft 18a so as to be fixed with respect to rotation relative to it. The second output on the second driven shaft 18b is carried out via the fourth ring gear 36b of the third planetary gearset 27, which fourth ring gear 36b is connected to the second driven shaft 18b so as to be fixed with respect to rotation relative to it.

According to a fourth alternative embodiment example of the powertrain 2 shown in FIG. 7, the gear unit 3 is arranged axially between the electric machine 11 and the differential 16, the differential 16 being arranged on the output axis 17 which is arranged paraxial to the input axis 33 in the present case. Accordingly, the input shaft 29 and the output shaft 12 of the gear unit 3 are also arranged on the input axis 33. The output shaft 12 is drivingly connected via a transmission stage 24 which, in the present case, is formed to be single-stage and which comprises a third toothed wheel 39a which is connected to the output shaft 12 so as to be fixed with respect to rotation relative to it and a fourth toothed wheel 39b which is operatively connected to the differential 16. In the present case, the toothed wheels 39a, 39b are configured as spur gears so that the transmission stage 24 consequently comprises a spur gear stage. The overall gear ratio of the powertrain 2 is realized by the transmission stage 24 by suitably configured toothed wheel diameter and number of teeth. In this respect, an additional planetary gear assembly 14 corresponding to the embodiment examples according to FIG. 4 and FIG. 5 can be dispensed with. However, depending on the requirements of the powertrain, it may be useful to provide a further gear unit for increasing a total gear ratio. As a result of the paraxial arrangement of the powertrain components, axial installation space is economized in the powertrain 2, that is, in particular in that the electric machine 11 together with the gear unit 3 and the differential 16 are arranged at least partially adjacent one another. In this way, the electric machine 11 can also be made more slender, which in turn has a positive effect on the axial spacing between the input axis 33 and output axis 17. In the present case, the differential 16 is configured as a bevel gear differential and, further, is identical to the differential 16 according to FIG. 4. Reference is made to the relevant statements.

In the present case, the gear shifting elements 5, 6 of the gear unit 3 are formed in each instance as a disk-type shifting element and realize in each instance a frictionally engaging connection between the housing 13 of the gear unit 3 and the first sun gear 7a or second sun gear 7b, respectively, in the closed state. In this regard, it is advantageous that both traction shifts and coasting shifts can be power-shifted between the gear steps E1 and E2, or vice versa. In other words, the gear shifting elements 5, 6 are power shifting elements in the present case. The load during shifting processes between the gear steps E1, E2 can be supported by the first gear shifting element 5 until the second gear shifting element 6 is completely open or closed, or vice versa, thereby preventing a load decrease at the output particularly during shifting processes. Consequently, the powertrain 2 according to FIG. 7 comprises the gear unit from FIG. 2 with the difference that the two gear shifting elements 5, 6 are configured as disk-type shifting elements. Therefore, reference is made to the statements relating to the gear unit 3 from FIG. 2. As regards the shifting between the first gear step E1 and second gear step E2, reference is made to the description relating to FIG. 3. Alternatively, the two gear shifting elements 5, 6 can be configured as in the embodiment form according to FIG. 4, FIG. 5 or FIG. 6.

FIG. 8 shows a fifth embodiment example of the powertrain 2 in which the gear unit 3 is arranged axially between the electric machine 11 and the differential 16. Analogous to FIG. 7, the differential 16 is arranged on the output axis 17 paraxial to the input axis 33 on which the output shaft 12 of the gear unit 3 lies. The output shaft 12 of the gear unit 3 is operatively connected to the differential 16 via two transmission stages 24, 40. The first transmission stage 24 comprises a third toothed wheel 39a which is connected to the output shaft 12 so as to be fixed with respect to rotation relative to it and a fourth toothed wheel 39b which is connected to an intermediate shaft 32 arranged paraxial to the input axis 33 and output axis 17 so as to be fixed with respect to rotation relative to the intermediate shaft 32. Axially adjacent the fourth toothed wheel 39b, a fifth toothed wheel 39c of the second transmission stage 40 is arranged on the intermediate shaft 32 so as to be fixed with respect to rotation relative to it, this intermediate shaft 32 being in meshing engagement with a sixth toothed wheel 39d operatively connected to the differential 16. The overall gear ratio of the powertrain 2 is generated by the transmission stages 24, 40 by correspondingly configuring the toothed wheel diameters and number of teeth of the toothed wheels 39a-39d. The toothed wheels 39a-39d are formed in the present instance as spur gears, and the transmission stages 24, 40 are consequently spur gear stages. In this regard, an additional planetary gear assembly 14 corresponding to the embodiment examples according to FIG. 4 and FIG. 5 can be dispensed with. However, depending on the requirement for the powertrain 2, it may be useful to provide a further gear unit for increasing a total gear ratio. Axial installation space is saved in the powertrain 2 through the paraxial arrangement of the powertrain components, particularly in that the electric machine 11 together with the gear unit 3 and the differential 16 are arranged at least partially adjacent one another. Accordingly, the electric machine 11 can be made more slender, which in turn has a positive effect on the axial spacing between the input axis and output axis.

The two gear shifting elements 5, 6 of the gear unit 3 are arranged directly adjacent one another coaxial to the input axis 33 and together form a double shifting element which combines the two gear shifting elements 5, 6. In the present case, the gear shifting elements 5, 6 are each configured as jaw-type shifting elements as in the embodiment example according to FIG. 5 to which reference is made. For the shifting between the first gear step E1 and second gear step E2, reference is made to the description relating to FIG. 3. Further, reference is made to the statements relating to FIG. 7 and the reference numerals used therein, particularly to FIG. 2 and FIG. 5. Alternatively, the two gear shifting elements 5, 6 can be configured as in the respective embodiment form according to FIG. 4, FIG. 6 or FIG. 7. As a further alternative, the gear unit 3 can be arranged inside of the rotor 19 as in the embodiment forms according to FIG. 5 and FIG. 6.

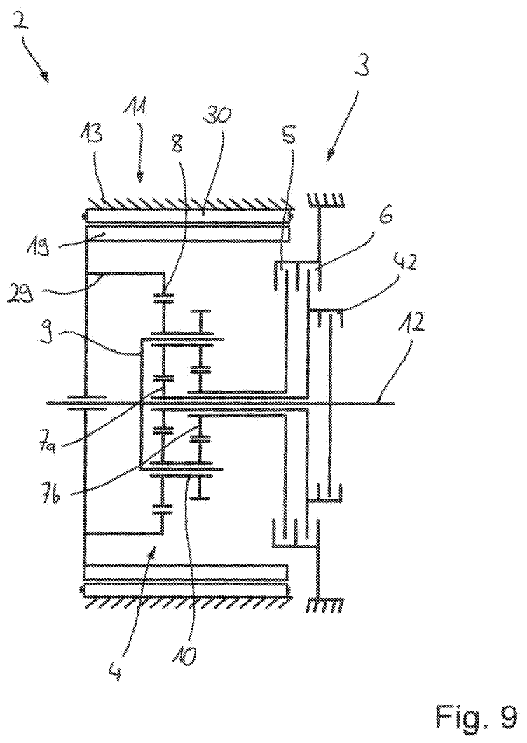

FIG. 9 shows a portion of a powertrain 2 corresponding to a sixth embodiment form of the invention. This powertrain 2 substantially corresponds to the variant according to FIG. 4 with the difference that a further, third gear shifting element 42 is provided in addition to the first gear shifting element 5 and the second gear shifting element 6 and, when in the actuated state, the third gear shifting element 42 connects the output shaft 12 and, therefore, the first planet carrier 9 to the first sun gear 7a of the stepped planetary gearset 4 so as to be fixed with respect to rotation relative to it. Actuation of the third gear shifting element 42 brings about a locking of the stepped planetary gearset 4 and, accordingly, a direct through-drive is made from the input shaft 29 of the gear unit 3 to the output shaft 12.

A further distinction consists in that the gear shifting elements 5, 6 and 42 are each constructed as frictionally engaging shifting elements; in particular, the individual gear shifting element 5 or 6 or 42 is configured as a disk-type shifting element. While the stepped planetary gearset 4 is arranged axially level with and radially inwardly of the electric machine 11, the gear shifting elements 5, 6 and 42 are provided to lie radially inwardly of and at least partially axially adjacent the electric machine 11. In so doing, gear shifting element 5 partially axially overlaps the electric machine 11 and is followed axially first by gear shifting element 11 and lastly by gear shifting element 42. The latter is provided radially inwardly relative to the gear shifting elements 5 and 6 which are arranged radially substantially on the same level. Further, in a manner analogous to the preceding variants, a coupling to a differential 16 or 25 is produced at the output shaft 12 of the gear unit 3. In other respects also, the embodiment form according to FIG. 9 corresponds to the variant according to FIG. 4, so that reference is had to the description in this regard.

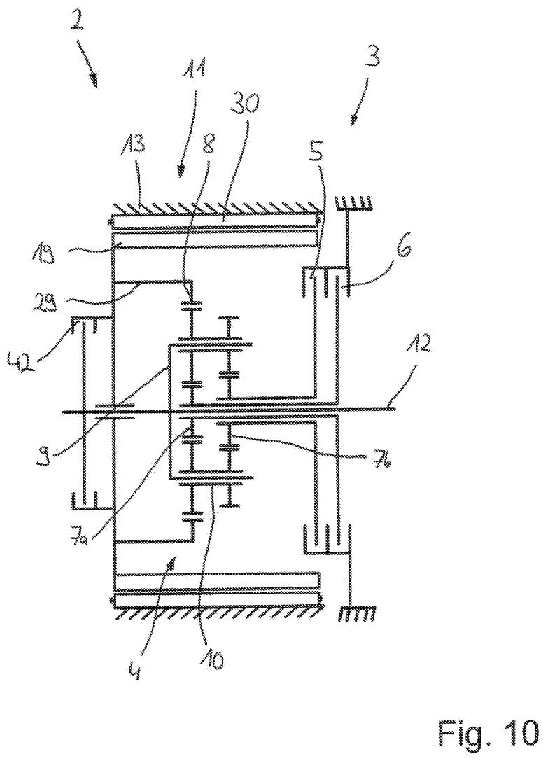

FIG. 10 shows a portion of a further powertrain 2 according to the invention which corresponds to a great extent to the preceding variant according to FIG. 9 with the difference that the third gear shifting element 42, when actuated, now connects the output shaft 12 and, therefore, the first planet carrier 9 to the input shaft 29 and, therefore, to the first ring gear 8 so as to be fixed with respect to relative rotation. This again results in a locking of the stepped planetary gearset 4. Further, the third gear shifting element 42 is now arranged axially on a side of the electric machine 11 remote of the gear shifting elements 5 and 6. In other respects, the embodiment form according to FIG. 10 corresponds to the variant according to FIG. 9, so that reference is had to the description in this regard.

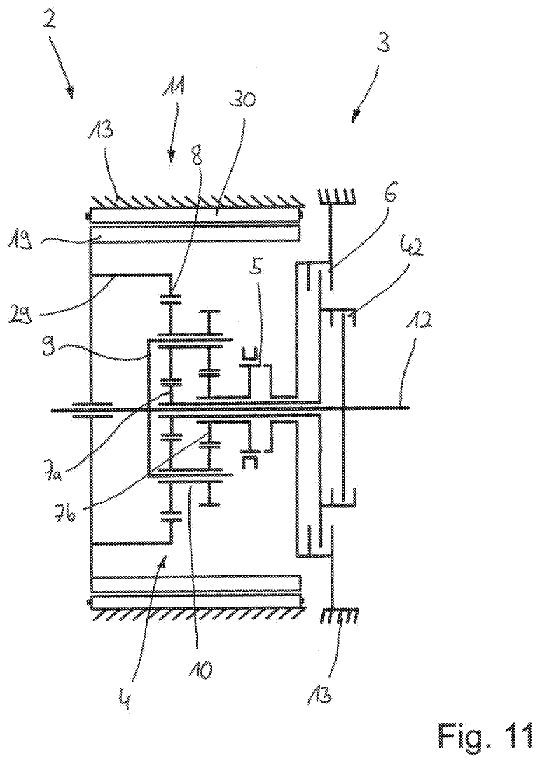

Further, FIG. 11 shows a portion of a powertrain 2 according to a further embodiment form of the invention. This embodiment form also substantially corresponds to the variant according to FIG. 9. In contrast to the variant according to FIG. 9, the first gear shifting element 5 in gear unit 3 is now configured as positively engaging shifting element as in the variant of the gear unit 3 according to FIG. 2. In this instance, the first gear shifting element 5 presents in particular as an unsynchronized jaw-type shifting element. The first gear shifting element 5 is arranged axially level with and radially inwardly of the electric machine 11, the first gear shifting element 5 being situated axially between the stepped planetary gearset 4 and the second gear shifting element 6. In other respects, the embodiment form according to FIG. 11 corresponds to the variant according to FIG. 9, so that reference is had to the description in this regard.

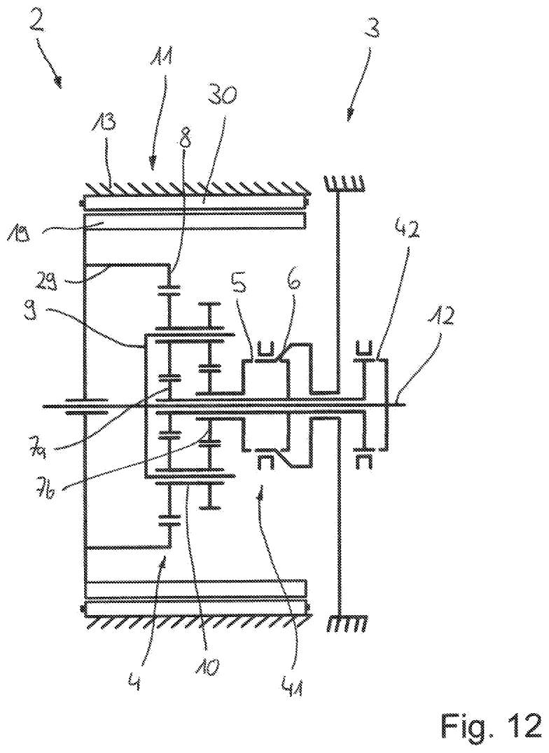

FIG. 12 shows a portion of a powertrain 2 which is constructed corresponding to a further configuration possibility of the invention and substantially corresponds to the embodiment form according to FIG. 9 with the difference that now all three gear shifting elements 5, 6 and 42 are configured as positively engaging shifting elements. The gear shifting elements 5, 6 and 42 are preferably configured as unsynchronized jaw-type shifting elements. Further, as in the variant according to FIG. 5, the first gear shifting element 5 and the second gear shifting element 6 form a double shifting element 41 which is provided axially level with and radially inwardly of the electric machine 11. In other respects, the configuration possibility according to FIG. 12 corresponds to the variant according to FIG. 9, so that reference is had to the description in this regard.

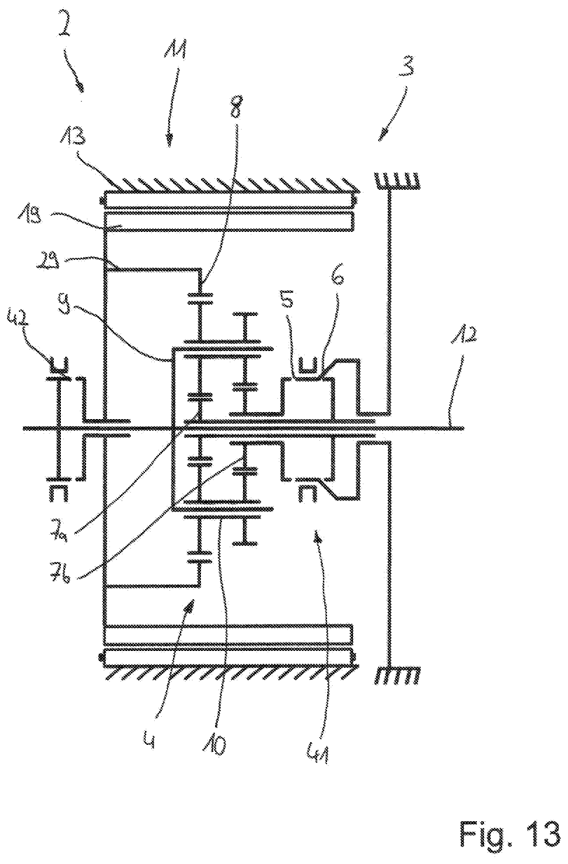

Further, FIG. 13 shows a portion of a powertrain 2 according to a further embodiment form of the invention. This embodiment form substantially corresponds to the preceding variant according to FIG. 12 with the difference that in this case, as in the variant according to FIG. 10, the third gear shifting element 42, when actuated, brings about a locking of the stepped planetary gearset 4 in that the third gear shifting element 42 in the actuated state connects the output shaft 12 and, therefore, the first planet carrier 9 to the input shaft 29 and, therefore, to the first ring gear 8 so as to be fixed with respect to relative rotation. In comparison to the variant according to FIG. 12, the third gear shifting element 42 is arranged axially on an opposite side of the electric machine 11. Otherwise, the embodiment form according to FIG. 13 corresponds to the variant according to FIG. 12, so that reference is had to the description in this regard.

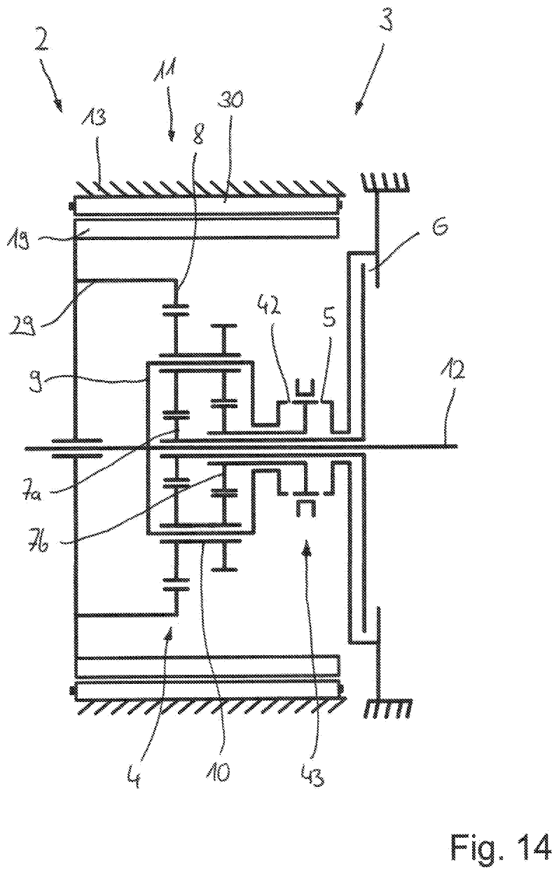

FIG. 14 shows a portion of a powertrain 2 corresponding to a further configuration possibility of the invention. This configuration possibility substantially corresponds to the variant according to FIG. 9 with the difference that the first gear shifting element 5 and the third gear shifting element 42 are configured as positively engaging shifting elements particularly in the form of unsynchronized jaw-type shifting elements and form a double shifting element 43. Further, in the actuated state of the third gear shifting element 42, a locking of the stepped planetary gearset 4 is achieved in that the output shaft 12 and, therefore, the first planet carrier 9 is connected to the second sun gear 7b so as to be fixed with respect to rotation relative to it. The double shifting element 43 is provided axially level with and radially inwardly of the electric machine 11, the third gear shifting element 42 being situated axially between the stepped planetary gearset 4 and the first gear shifting element 5. Otherwise, the embodiment form according to FIG. 14 corresponds to the variant according to FIG. 9, so that reference is had to the description in this regard.

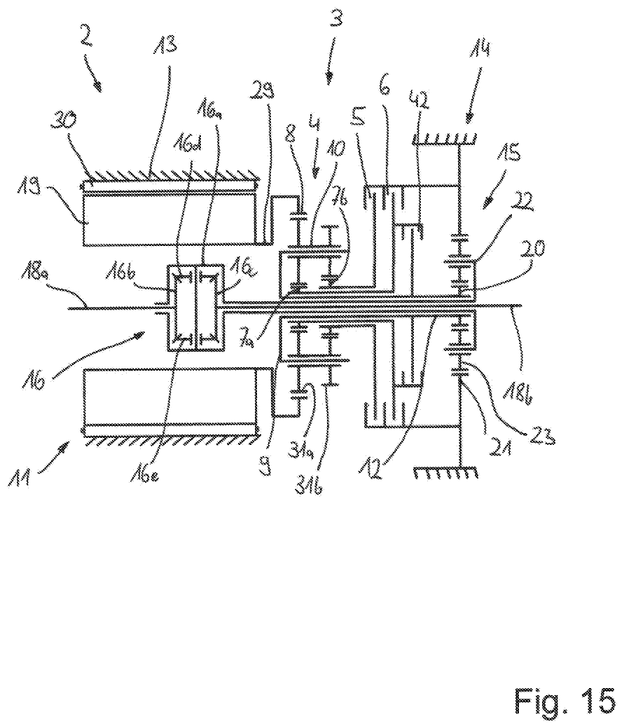

FIG. 15 is a view of a powertrain 2 according to an embodiment form of the invention. This embodiment form substantially corresponds to the variant according to FIG. 4. This embodiment form differs from the variant according to FIG. 4 in that, as in the configuration according to FIG. 9, the third gear shifting element 42 is now additionally provided in the gear unit 3 of the powertrain 2 and, in the actuated state, the third gear shifting element 42 brings about a locking of the stepped planetary gearset 4 in that the output shaft 12 and the first sun gear 7a are connected so as to be fixed with respect to relative rotation. As in the variant according to FIG. 9, the gear shifting elements 5, 6 and 42 are configured in each instance as frictionally engaging shifting elements, in particular, in the form of disk-type shifting elements. The gear shifting elements 5, 6 and 42 axially follow the stepped planetary gearset 4 in the sequence of first gear shifting element 5, second gear shifting element 6 and, lastly, third gear shafting element 42. Otherwise, the embodiment form according to FIG. 15 corresponds to the variant according to FIG. 4, so that reference is had to the description in this regard.

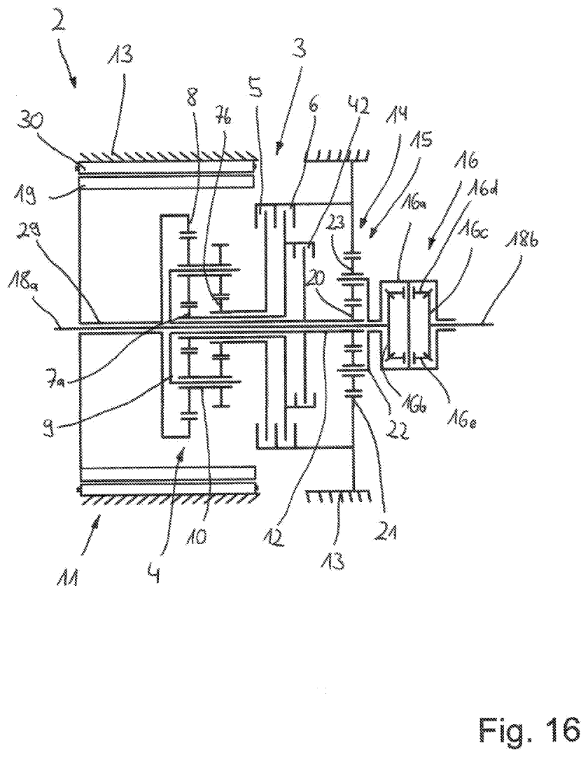

FIG. 16 shows a further configuration possibility according to the invention for a powertrain 2. This configuration possibility substantially corresponds to the variant according to FIG. 5 with the difference that the gear unit 3 of this powertrain 2 is configured according to the variant in FIG. 9 in that the third gear shifting element 42 is provided in addition to the first gear shifting element 5 and the second gear shifting element 6. In the actuated state, this third gear shifting element 42 connects the output shaft 12 and, therefore, the first planet carrier 9 to the first sun gear 7a so as to be fixed with respect to relative rotation, resulting in a locking of the stepped planetary gearset 4. The gear shifting elements 5, 6 and 42 are configured in each instance as frictionally engaging shifting elements, preferably in the form of disk-type shifting elements. The gear shifting elements 5, 6 and 42 axially follow the electric machine 11 in the sequence 5, 6 and, lastly, 42. The gear shifting elements 5, 6 and 42 are situated axially between the electric machine 11 and the stepped planetary gearset 4 on the one side and the planetary gear assembly 14 on the other side. Otherwise, the configuration possibility according to FIG. 16 corresponds to the variant according to FIG. 5, so that reference is had to the description in this regard.

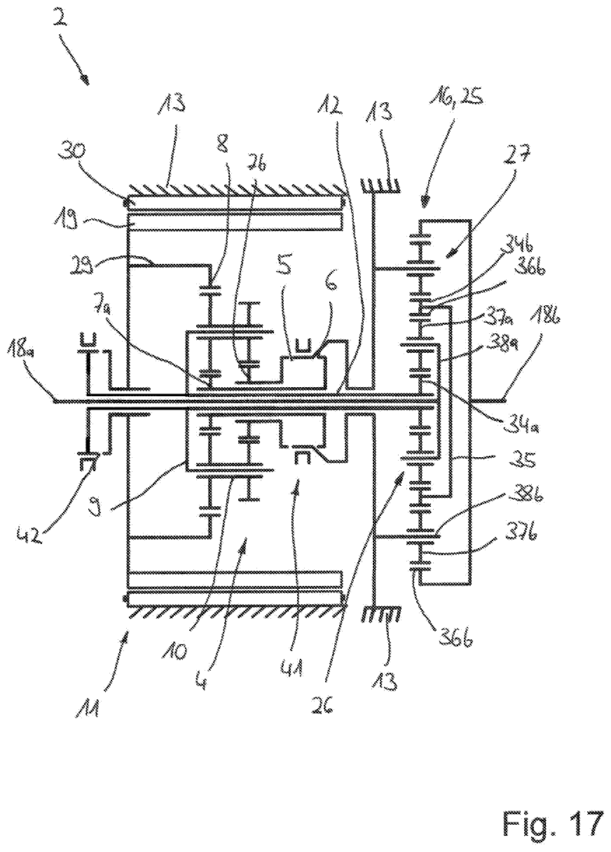

FIG. 17 shows an embodiment form of a powertrain 2 according to the invention which substantially corresponds to the variant according to FIG. 6. In contrast to the variant according to FIG. 6, the gear unit 3 of the powertrain 2 is formed analogous to the variant according to FIG. 13 in that the gear shifting elements 5 and 6 form a double shifting element 41, and a third gear shifting element 22 in actuated state brings about a locking of the stepped planetary gearset 4. This is achieved in that the third gear shifting element 42, when actuated, connects the output shaft 12 and, therefore, the first planet carrier 9 to the input shaft 29 and, therefore, to the first ring gear 8 so as to be fixed with respect to relative rotation. The third gear shifting element 42 is located axially on a side of the electric machine 11 remote of the differential 16. In other respects, the embodiment form according to FIG. 17 corresponds to the variant according to FIG. 6, so that reference is had to the description in this regard.

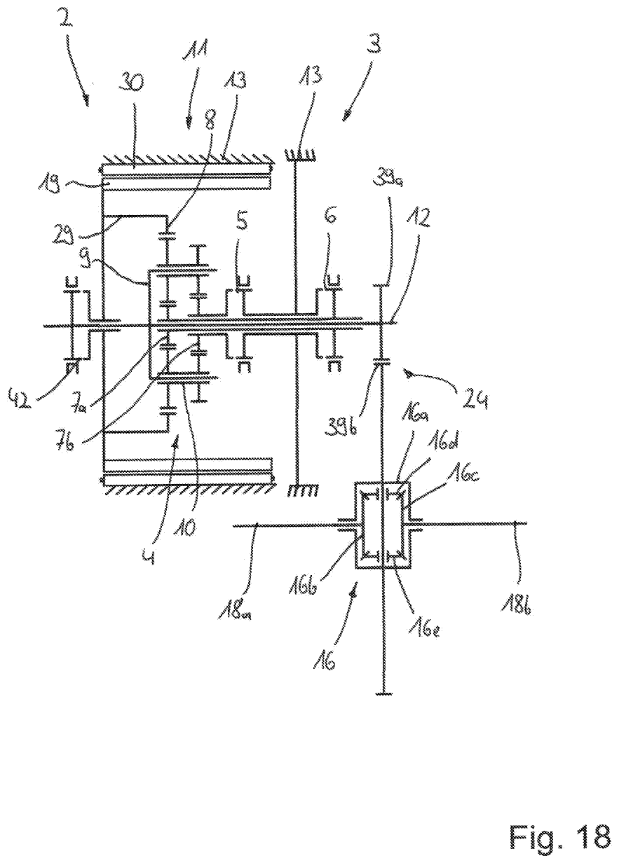

FIG. 18 shows a further embodiment form, according to the invention, of a powertrain 2. This embodiment form substantially corresponds to the variant according to FIG. 13 with the difference, for one, that the two gear shifting elements 5 and 6 now do not form a double shifting element, but rather are constructed as individual shifting elements. Further, the second gear shifting element 6 is not located axially level with the electric machine 11, but rather axially adjacent the electric machine 11. Further, a coupling of the output shaft 12 with a differential 16 is carried out via a transmission stage 24, this coupling being realized analogous to the variant according to FIG. 7. To this extent, reference is had to the variant according to FIG. 7 in this respect. Otherwise, the embodiment form according to FIG. 18 corresponds to the variant according to FIG. 13, so that reference is had to the description in this regard.

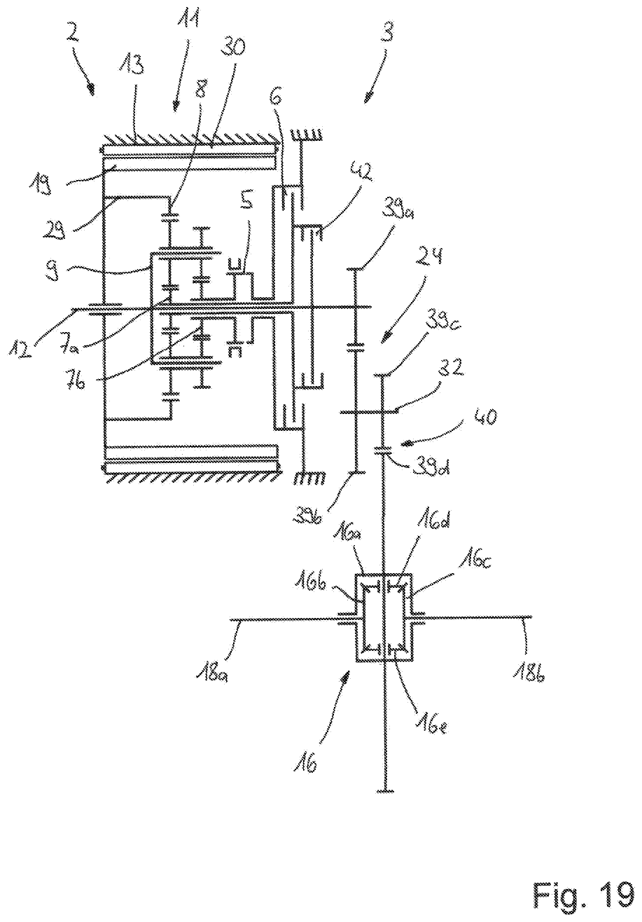

Further, FIG. 19 shows a further configuration possibility, according to the invention, of a powertrain 2 which substantially corresponds to the variant according to FIG. 11. The configuration possibility according to FIG. 19 differs from the variant according to FIG. 11 in that the output shaft 12 is now coupled with a differential 16 via a first transmission stage 24 and a second transmission stage 40, this coupling being carried out analogous to the variant according to FIG. 8. With regard to the coupling, reference is had to the description referring to FIG. 8. Otherwise, the embodiment form according to FIG. 19 corresponds to the variant according to FIG. 11, so that reference is had to FIG. 11.

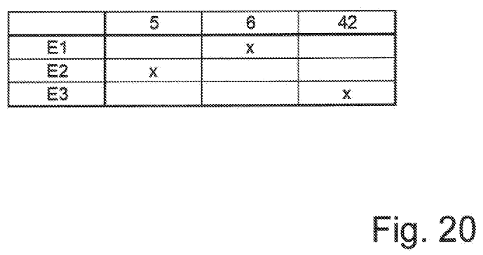

Lastly, FIG. 20 shows a schematic diagram of a shifting matrix which relates to shifting states for driving with a gear unit according to the invention in accordance with one of the variants shown in FIGS. 9 to 19. In this respect, a first gear E1 and a second gear E2 are shown analogous to the description referring to FIG. 3, but now a third gear E3 can be engaged in addition by actuating the third gear shifting element 42. Depending on the configuration of the gear shifting elements 5, 6 and 42, a traction power shift and/or coasting power shift can be realized. In such a case, the respective gear shifting element 5 or 6 or 42, respectively, is configured as a power shift element.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### REFERENCE CHARACTERS

1 vehicle
2 powertrain
3 gear unit
4 stepped planetary gearset
5 first gear shifting element
6 second gear shifting element
7a first sun gear
7b second sun gear
8 first ring gear
9 first planet carrier
10 stepped planet gears
11 electric machine
12 output shaft of the gear unit
13 housing
14 planetary gear assembly
15 first planetary gearset
16 differential
16a differential carrier
16b first driven wheel of the differential
16c second driven wheel of the differential
16d compensating element of the differential
16e compensating element of the differential
17 output axis
18a first driven shaft
18b second driven shaft
19 rotor of the electric machine
20 third sun gear
21 second ring gear
22 second planet carrier
23 first planet gear
24 first transmission stage
25 integral differential
26 second planetary gearset
27 third planetary gearset
28 wheel of the vehicle
29 input shaft of the gear unit
30 stator of the electric machine
31a first toothed wheel of the stepped planetary gear
31b second toothed wheel of the stepped planetary gear
32 intermediate shaft
33 input axis
34a second sun gear of the integral differential
34b fifth sun gear of the integral differential
35 coupling shaft of the integral differential
36a third ring gear
36b fourth ring gear
37a second planet gear
37b third planet gear
38a third planet carrier
38b fourth planet carrier
39a third toothed wheel of the transmission stage
39b fourth toothed wheel of the transmission stage
39c fifth toothed wheel of the transmission stage
39d sixth toothed wheel of the transmission stage
40 second transmission stage
41 double shifting element
42 third gear shifting element
43 double shifting element
E1 first gear
E2 second gear
E3 third gear

1. A gear unit (3) for a powertrain (2) of an at least partially electrically driven vehicle (1), comprising a stepped planetary gearset (4), a first gear shifting element (5) and a second gear shifting element (6), wherein the stepped planetary gearset (4) has a first sun gear (7a), a second sun gear (7b), a first ring gear (8) and a plurality of stepped planet gears (10) rotatably mounted on a first planet carrier (9), wherein the first ring gear (8) is configured to be drivingly connectable to an electric machine (11), wherein the first planet carrier (9) is connectable to an output shaft (12) of the gear unit (3) so as to be fixed with respect to rotation relative to it, wherein the first gear shifting element (5) is configured to fix the second sun gear (7b) relative to a housing (13) in a closed state, wherein the second gear shifting element (6) is configured to fix the first sun gear (7a) relative to the housing (13) in a closed state, and wherein one of the two gear shifting elements (5, 6) is in the closed state for driving the output shaft (12) in rotation.

2. The gear unit (3) according to claim 1, further comprising a third gear shifting element (42) configured to, in a closed state, connect two of the elements of the stepped planetary gearset (4) in the form of the first sun gear (7a), the second sun gear (7b), the first ring gear (8) and the first planet carrier (9) to one another so as to be fixed with respect to rotation relative to one another, and wherein, due to the closed state of the third gear shifting element (42), there is a rotational driving of the output shaft (12).

3. The gear unit (3) according to claim 2, wherein the third gear shifting element (42) is configured as a positively engaging shifting element.

4. The gear unit (3) according to claim 2, wherein the third gear shifting element (42) is configured as a frictionally engaging shifting element.

5. The gear unit (3) according to claim 4, wherein the first gear shifting element (5) is configured as a positively engaging shifting element.

6. The gear unit (3) according to claim 4, wherein the first gear shifting element (5) is configured as a frictionally engaging shifting element.

7. The gear unit (3) according to claim 1, wherein the second gear shifting element (6) is configured as a positively engaging shifting element.

8. The gear unit (3) according to claim 1, wherein the second gear shifting element (6) is configured as a frictionally engaging shifting element.

9. The gear unit (3) according to claim 1, wherein two gear shifting elements (5, 6; 5, 42) are configured jointly as a double shifting element (41; 43).

10. A powertrain (2) for an at least partially electrically driven vehicle (1), comprising the gear unit (3) according to claim 1, an electric machine (11) and a differential (16) configured to drivingly connect the gear unit (3) to two driven shafts (18a, 18b) arranged coaxial to an output axis (17).

11. The powertrain (2) according to claim 10, wherein the differential (16) is configured as a bevel gear differential.

12. The powertrain (2) according to claim 11, further comprising a planetary gear assembly (14) drivingly connectable to the output shaft (12) of the gear unit (3) and has at least a first planetary gearset (15).

13. The powertrain (2) according to claim 12, wherein the first planetary gear set (15) of the planetary gear assembly (14) has a third sun gear (20), a second ring gear (21) which is fixed with respect to the housing, and a plurality of planet gears (23) rotatably mounted at a second planet carrier (22), wherein the third sun gear (20) is connectable to the first planet carrier (9) of the gear unit (3) so as to be fixed with respect to rotation relative to it.

14. The powertrain (2) according to claim 13, wherein a differential carrier (16a) of the differential (16) is connectable to the second planet carrier (22) of the planetary gear assembly (14) so as to be fixed with respect to rotation relative to it.

15. The powertrain (2) according to claim 14, wherein the gear unit (3) and/or the differential (16) are/is arranged at least partially or completely spatially inside of a rotor (19) of the electric machine (11).

16. The powertrain (2) according to claim 15, wherein at least a first transmission stage (24) is drivingly arranged between the output shaft (12) of the gear unit (3) and the differential (16).

17. The powertrain (2) according to claim 10, wherein the differential (16) is configured as an integral differential (25) which has a second planetary gearset (26) and a third planetary gearset (27), wherein each planetary gearset (26, 27) is drivingly connectable to a respective driven shaft (18a, 18b), wherein a first output torque is transmittable to the first driven shaft (18a) by the second planetary gearset (26), and wherein a supporting torque of the second planetary gearset (26) is convertible in the third planetary gearset (27) such that a second output torque corresponding to the first output torque is transmittable to the second driven shaft (18b).

18. The powertrain (2) according to claim 17, wherein the integral differential (25) and the driven shafts (18a, 18b) are adapted to be arranged coaxial to an output axis (17) of the vehicle (1).
